(19) United States
(12) Patent Application Publication
(10) Pub. No.: US 2008/0181575 A1
(43) Pub. Date: Jul. 31, 2008

(54) VIDEO PLAYER FOR USE OVER COMMUNICATIONS NETWORK, SUCH AS STREAMING INTERNET VIDEO PLAYER WITH UNOBTRUSIVE ADVERTISING

(76) Inventors: Joe Girard, Vancouver (CA); Francesco Schiavon, Vancouver (CA); Jason Classon, Vancouver (CA); Ritchie Macapinlac, Vancouver (CA); Gagan Diesh, Burnaby (CA); Brett Forsyth, North Vancouver (CA)

Correspondence Address: PERKINS COIE LLP;PATENT-SEA, P.O. BOX 1247, SEATTLE, WA, 98111-1247, US

(21) Appl. No.: 11/945,847

(22) Filed: Nov. 27, 2007

Related U.S. Application Data
(60) Provisional application No. 60/867,381, filed on Nov. 27, 2006.

(51) Int. Cl. H04N 5/91

(52) U.S. Cl. 386/83

(57) ABSTRACT

A system for displaying educational, informational, commercial, and other types of video and other content via a communications network is disclosed. In some examples, the system comprises displaying via a client video player a digital video programme and related digital media content. The related digital media content is relevant to the digital video programme, and this relevancy is communicated to the user, such as via visual, aural, or other cues displayed in association with the related digital media content. The cues may be displayed during a duration of relevancy, or a time period in which the related digital media content is relevant to the digital video programme. The user may access the related digital media content before, during, or after display of the digital video programme, and before, during, or after the duration of relevancy. Related digital media content is presented upon selection of the content by the user.

### CROSS-REFERENCE TO RELATED APPLICATIONS

This application claims priority to, and incorporates by reference in its entirety, U.S. Provisional Application No. 60/867,381, filed on Nov. 27, 2006 (Attorney Docket No. 60960-8002.US00).

### BACKGROUND

As internet service subscribers have access to higher bandwidth networks, more advertisers are turning to the internet as a viable place for presenting digital video advertisements of products and services. Many of these advertisers turn to pre-roll ads, or advertisements that are played before content selected by a user is played. Generally, a cost per impression (CPM) pricing scheme is utilized, in which advertisers pay per impression, or each time an advertisement is displayed to a user. In other situations, advertisers place video ads on manufacturers' or other entities' websites in a commercial context. In many cases, these videos are isolated from relevant content and are presented in a context that only has relevancy to the characteristics of the advertised product. Other advertisers use online instructional video materials to attract customers to their websites and expose visitors to other advertisement mechanisms, such as banner ads embedded on the advertisers' web pages.

The need exists for a system that overcomes the above limitations, in addition to providing other benefits. Overall, the examples of prior or related systems and their associated limitations described herein are intended to be illustrative and not exclusive. Other limitations of existing or prior systems will become apparent to those of skill in the art upon reading the following Detailed Description.

### BRIEF DESCRIPTION OF THE DRAWINGS

FIG. 1A is a block diagram illustrating elements comprising a video programme in at least one suitable system.

FIG. 1B is a block diagram illustrating a video programme group in at least one suitable system.

FIG. 2 is a block diagram illustrating a suitable system in which aspects of the invention may operate in a networked computer environment.

FIGS. 3A and 3B are a flow diagram illustrating a suitable process by which a user interacts with the system.

FIG. 4A is a block diagram illustrating elements comprising a video programme group in at least one suitable system.

FIG. 4B is a block diagram illustrating elements comprising a video programme group in at least one suitable system.

FIG. 5 is a block diagram illustrating a link between video programmes in at least one suitable system.

FIG. 6 is a block diagram illustrating periods of relevancy for related media data in at least one suitable system.

FIG. 7 is a display diagram illustrating a user interface for a video programme presented by a video player in at least one suitable system.

FIG. 8 is a display diagram illustrating a user interface for related media data presented by a video player in at least one suitable system.

### DETAILED DESCRIPTION

As advertisers look for ways to present their products in an increasingly diluted environment of multiple ads and brands, they are willing to invest in methods that can offer them qualified customers. For example, a stove manufacturer may want to advertise its products on a food related website, but the stove ads will compete with other unrelated products for attention and space on the website, diluting the message of the stove manufacturer. The system described in detail below offers a way for advertisers to present their advertisements in a simplified or clean environment, avoiding “in-your-face advertising” (banners, pop-ups, roll downs, etc.) and, more importantly, offers advertisers targeted and pre-qualified prospective consumers.

In the past, one of the approaches used by advertisers was “interactive video,” where a user was expected to click on a moving hotspot on a video as it played. For example, an advertiser may choose to promote a polo shirt used by a golf player by presenting a video of the player wearing the polo shirt and allowing a user to purchase the shirt by clicking on a hotspot associated with the displayed shirt. However, users often do not want to interact with moving video. Even worse, many users do not even know that they can interact with moving video. Even when prompted to interact with the video, users often do not know which portion of the video is the hotspot (for example, viewers may click on golf clubs in the video instead of the shirt). In addition, viewers must click on the moving hotspot while it is on the screen. The system described in detail below overcomes these and other difficulties by presenting the user with the option to access at any time further information that is relevant to the video content, without requiring the user to click on the video in order to access the additional information.

Other forms of “contextual” advertisement on video involve displaying advertisement links overlaid on top of the video content. In this case the audience has no option but to see the advertisement that often detracts from the main video content and may not even be relevant to the content of the main video programme. Yet other forms of “contextual” video advertisement present the user with adjacent (side by side) commercial video content that updates as the main video programme plays. In this scenario the user has the option to play the commercial content to the side of the main programme, but has no ability to hide or disable the commercial content. In these scenarios the user has no way to opt-out from the “contextual” advertisements and the content of the advertisements may not be completely related to the main video programme.

From a learning environment perspective, many Learning Management Systems (LMS) focus on tracking learners' progress by presenting learners with a curriculum that must be followed. In this model, the learner must advance through the first levels of the curriculum before gaining access to the higher levels, regardless of whether s/he already has the necessary skill set. In the system presented here, the learner is assumed to have a certain level of understanding when s/he accesses desired content. If the learner does not have the minimum level of understanding necessary for a task presented, s/he can then access the necessary foundation skills to accomplish the task.

Various embodiments of the invention will now be described. The following description provides specific details for a thorough understanding and enabling description of these embodiments. One skilled in the art will understand, however, that the invention may be practiced without many of these details. Additionally, some well-known structures or functions may not be shown or described in detail, so as to avoid unnecessarily obscuring the relevant description of the various embodiments.

The terminology used in the description presented below is intended to be interpreted in its broadest reasonable manner, even though it is being used in conjunction with a detailed description of certain specific embodiments of the invention. Certain terms may even be emphasized below; however, any terminology intended to be interpreted in any restricted manner will be overtly and specifically defined as such in this Detailed Description section.

A method and system for displaying educational, informational, commercial, and other types of video and other content via a communications network is disclosed. In some examples, the method and system comprise displaying digital video content via a computer network and, more particularly, comprise displaying digital video content and other media that are relevant to the content in the video.

The system allows a user to request a desired video programme to be displayed in a client video player. A video programme may be selected by the user in a variety of ways, including from a list of video programmes displayed on a website, a menu in the client video player, a link in an email, or in another manner. A server computer system processes the request and sends links or other identifiers to video and other content files associated with the video programme to the client video player. The client video player presents the user with a user interface by which the user may access the video and other content files.

In some examples, the system comprises background music that is separate from the audio track of the video programmes. The user has volume controls for both the video programme as well the background music.

In some examples, video programmes are displayed as a series of sequential video subelements (e.g., steps of an overall process). When the user selects playback of a video subelement, the client video player requests downloading, streaming, or other transfer of video and other content comprising the video subelement from the server.

In addition, video subelements may include for a period of time related media data (or “drill down information”) relevant to the video subelement. The system allows the user to access media data related to a video subelement only if and when the user chooses to do so. The related media data offers the user an opportunity to augment his or her understanding of the video programme experience through educational, commercial, and other information not necessarily available in the main video programme, including via links to resources external to the client video player.

If a video subelement contains related media data, the client video player communicates to the user the related media data and the relationship between the related media data and the associated video subelement. In some examples, the system communicates the relationship between the related media data and the associated video subelement via a visual, aural, or other cue during playback of the video subelement. For example, the video player may display a highlighted link to additional information related to the video subelement. In some examples, the cue remains displayed by the video player for a duration of time in which the related media data is relevant to the video subelement.

The system provides the user with the option to access the related media data before, during, and/or after playback of the video subelement with which it is associated. If the user requests display of related media data, the client video player sends a request to the server to download, stream, or otherwise transfer the related media data or other information. In some examples, if the video subelement is in playback mode when the related media data is requested, the client video player pauses the video subelement. The related media data is then displayed to the user. In some examples, the related media data is displayed atop the video programme. The user interface may provide an option, such as a “close” button, that ends display of the related media data and returns the user to the main video programme.

Related media data may be created by an administrator of the system, third party partners (paid or non-paid), the community of user subscribers to the system, or another entity; there is no single source or type of related media data. In some examples, the user interface presented by the system may comprise buttons or other user interface elements that link to external resources for further information (e.g., “learn more”) and/or a commercial transaction (e.g., “purchase this product”) that are not part of the video programme. The external resources may include further educational information, commercial information, commercial services, or other information.

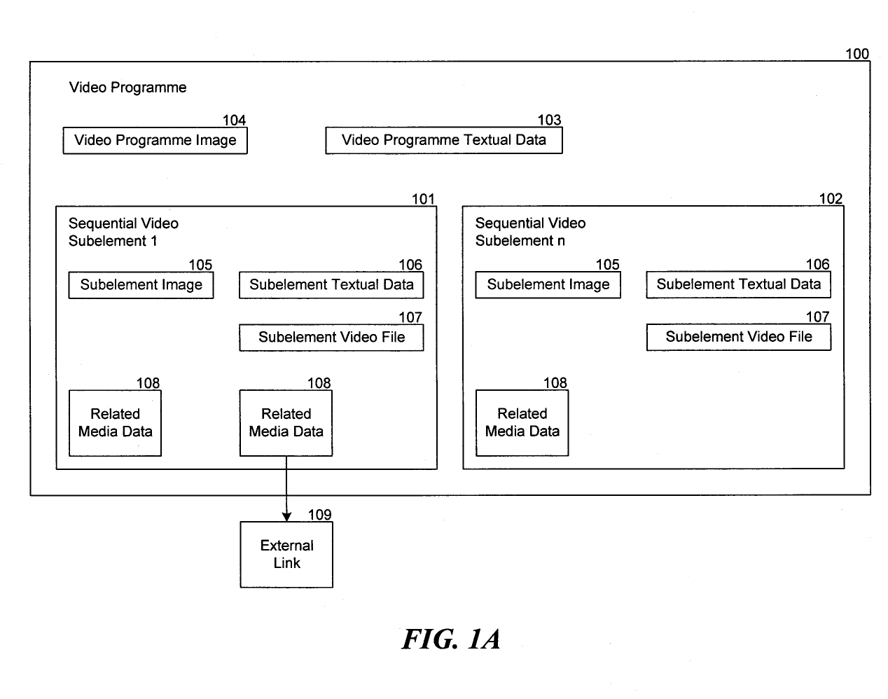

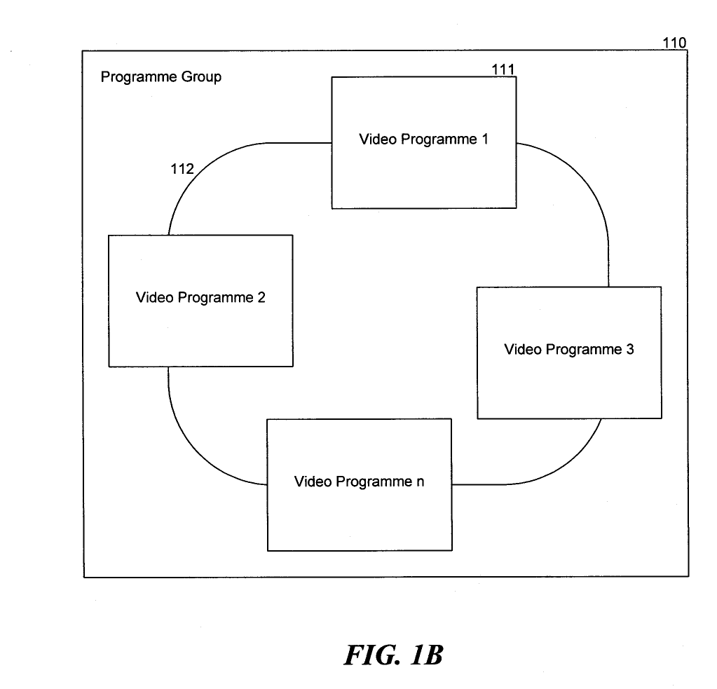

In some examples, the system comprises a collection of video programmes that are hosted on a server computer system. FIG. 1A illustrates elements comprising a video programme in at least one suitable system. Each video programme comprises at least one sequential video subelement 101 and may comprise multiple sequential video subelements 101 and 102. In addition, a video program comprises textual data 103 that may describe one or more aspects of the video programme, one or more representative images 104, and other information that pertains to the video programme. This information may include diagrams, photos, textual data, audio clips, etc. Each of the sequential video elements 101 and 102 comprises a representative subelement image 105, subelement textual data 106, and corresponding subelement video, audio, and other media files 107. The sequential video subelements may include related media data 108, which may comprise educational, informational, commercial, and/or other content.

In some examples, the related media data comprises video, sound, text, images, and/or other data. Alternatively or additionally, the related media data may include interactive files, such as Macromedia Flash files, or other types of computer files, such as HTML files. The related media data may include links 109 to resources external to the client video player. These external links may be to resources from the same domain as the client video player, a partner domain (i.e., paid drill down), and/or a third party domain. FIG. 1A depicts a video programme 100 that comprises two sequential video subelements 101 and 102, where the first subelement 101 has two related media data items 108 and the second subelement 102 has one related media data item 108.

FIG. 1B illustrates video programmes clustered together to form a video programme group 110 in at least one suitable system. Programme groups comprise video programmes 111 that together form new learning or informational relationships 112. For example, a group of video programmes, such as cooking recipes, may form a programme group, such as a full dinner meal.

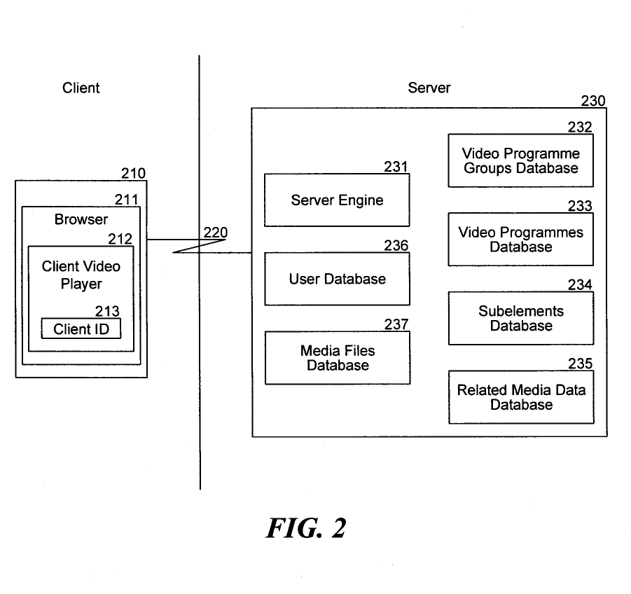

FIG. 2 illustrates a suitable system in which aspects of the invention may operate. The examples depicted by FIG. 2 may, for example, display educational, informational, commercial, and other types of video and other content over the internet using the world wide web. A client computer system 210 includes a browser 211 that connects to a server computer system 230 and that is used to display the client video player 212. The client video player 212, once loaded on the client computer system 210, makes requests to the server 230 and displays on the client 210 media files sent by the server in response to the request. The client computer system 210 also contains a client identifier 213, which is constantly pinging the server 230 to determine that the user is still running the client video player 212. In some examples, the server 230 assigns and sends the client identifier 213 to the client 210 once the user has logged in to the system. In some examples, with every message or request sent to the server 230, the client video player 212 sends the client identifier 213, as well as a unique identifier of each media file requested or viewed by the user, for identification and usage tracking purposes. The communications between the client video player 212 or browser 211 and the server 230 occur by exchanging information via communications link 220.

In some examples, the server 230 includes a server engine 231, a video programme groups database 232, a video programmes database 233, a subelements database 234, a related media data database 235, a user database 236, and a media files database 237. The server engine 231 receives HTTP or other requests to access media files on behalf of the user from the client video player 212. The requests are logged by the server engine 231. Based on the client identifier 213 sent with the request, as described above, the server engine 231 authenticates the user by matching the user to an entry in the user database 236 and records the user interaction with the client video player 212 as part of the user profile. The user may be authenticated through use of any of a number of known authentication methods. Once the user has been authenticated, the server engine 231 provides the requested media files 237 to the client video player 212 and tags each provided media file with an indication that the media file has been viewed by the user.

The video programme groups database 232 contains references indicating which video programmes form each programme group. Similarly, the video programmes database 233 contains references indicating which video subelements comprise each video programme. In addition, the video programmes database 233 contains the textual data, representative images, and other information that is associated with the video programmes, as well as the logical sequence in which each video subelement is to be displayed by the client video player 212. The subelements database 234 contains references to and unique identifiers of the media files that are associated with each video subelement. The subelements database 234 also includes the textual data, representative images, and other information that is associated with each of the video subelements. In addition, the subelements database 234 contains incremental counters for each media file, which track of the number of times that each media file is accessed by the client video player 212, for the purpose of maintaining usage statistics.

The related media data database 235 contains references to the media files that are associated with each of the related media data items. In addition, the related media database 235 contains references to the video subelements that identify the related media data items. In some examples, these references are created by an administrator of the system, automatically by means of meta data in the related media data items, and/or by other means. For each video subelement that identifies related media data items, the related media database 235 contains a time stamp for each of the related media data items. The time stamp marks the trigger point during playback of the video subelement when the related media data item becomes relevant to the content of the video subelement. For each time stamp, the related media database 235 also contains an indication of the duration for which the related media data item is relevant to the content of the video subelement. In addition, the related media data database 235 contains incremental counters for each related media data item, which track the number of times that each media file is accessed by the client video player 212, for usage statistics and user profiling purposes. The related media data database 235 also stores URLs or other identifiers for external elements that may be referenced by the related media data items and maintains incremental counters for each external element, which track the number of times the client video player 212 has accessed each external element.

The user database 236 contains a list of users, in addition to user identifiers and other personally identifiable information, such as name, email, and level of access, as well as historical usage information for each user. In some examples, the usage information includes which media files and related media data items have been accessed by the user. Usage statistics may be valuable to commercial and educational partners, and may facilitate billing advertisers on a cost per click (CPC) basis, as opposed to cost per impression (CPM) basis. Usage statistics may also be used to determine new related media to be offered to a unique user.

The media files database 237 comprises the video files, other visual data files (such as images), sound files (such as music or voiceover), and other media files (such as interactive object files, e.g., Macromedia Flash files, etc.) accessed by the client video player 212 in displaying video programmes and programme groups. As described above, the media files maintained by the media files database 237 are referenced by the video programmes database 233, the subelements database 234, and the related media data database 235.

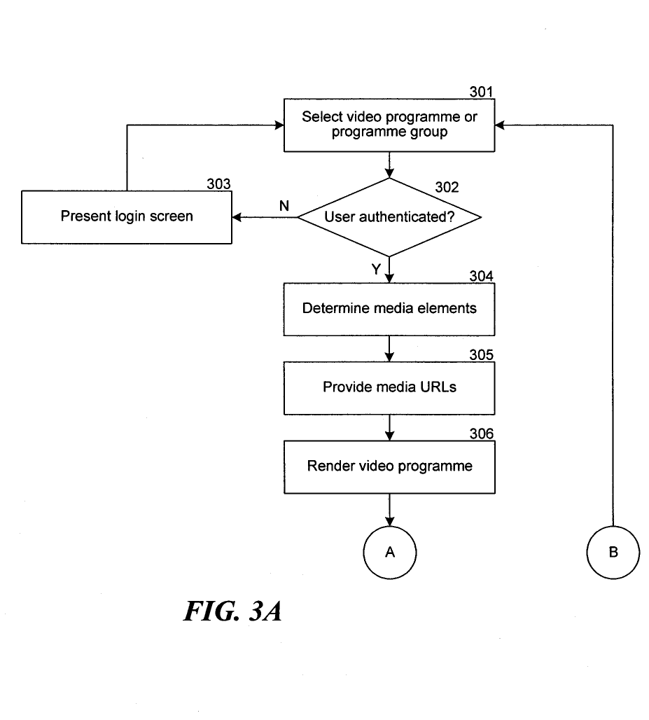

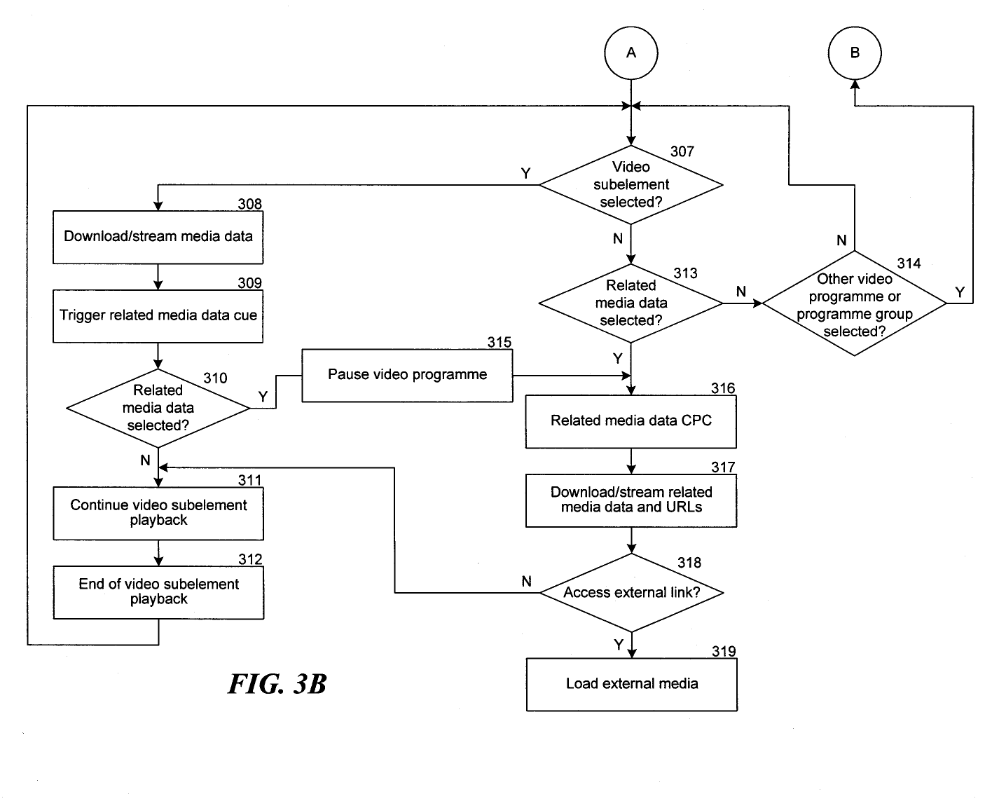

FIGS. 3A and 3B illustrate a suitable process by which a user accesses and interacts with the system. Beginning with FIG. 3A, at block 301, the user selects a video programme or programme group to be displayed by the client video player. For example, the user may select a video programme from a list of available programmes and groups on a website, from a video player menu, from a link in an email, or in another manner. The client video player sends the request to the server, along with a unique identifier associated with the user for tracking and authentication purposes.

At block 302, the server authenticates the user against a user database, such as that depicted by block 236 in FIG. 2. As described above, the user may be authenticated by any of a number of known authentication methods. If at block 302 the user is not authenticated successfully, at block 303, the server sends a login web page to the user that allows the user to login or subscribe to the system. Alternatively, if at block 302 the server successfully authenticated the user, at block 304, the server determines the sequential video subelements, media files, related media data, and other information that comprises the selected video programme or programme group.

At block 305, the server sends URLs or other identifiers for each media file, as well as any textual data, representative images, external links and other information that comprises the subelements and related media data, to the client video player. Some of the media data may be sent at the same time as the URLs or other identifiers, to expedite the playback experience by loading the initial media. For example, the textual data for the video programme and the video data of the first video subelement may be sent, to reduce waiting time once the user selects to play the first video subelement.

At block 306, the client video player renders the user interface based on the structure of the video programme selected, such as the number of sequential video elements that comprise the video program. For example, a video programme that comprises more sequential video elements may be rendered in a different manner than a video programme that comprises fewer sequential video elements. In addition, the client video player displays the initial media, such as a representative image for the first video subelement, background music for the client player, and other elements.

Once the initial media is rendered by the client player, the user has total flexibility on how to access the video programme media. That is, although the user interface of the client video player is intended to play video programme elements sequentially, the user may choose to access the media in a non-sequential manner. The user may choose to play one of the video subelements (not necessarily in sequential order), access any of the related media data items, or access a different video programme or programme group than the current video programme or programme group.

Turning to FIG. 3B, if at block 307 the user selects to play any of the video subelements, at block 308, the server downloads, streams, or otherwise transfers the media files for the selected video subelement, along with the unique identifier of the media files for statistical purposes. Once one or more of the media files have been transferred to the client video player, the video subelement starts playback.

If the video subelement contains related media data, at block 309, when a related media data item becomes relevant to the content of the video subelement (i.e., at the trigger point or start point of the period of relevancy), a visual, aural, or other cue is displayed or played by the client video player. The cue informs the user that the related media data item is relevant to the content currently being presented by the video subelement. In some examples, the system continues to display or play the cue for a period of time for which the related media data item is relevant to the content of the video subelement (i.e., a duration of relevancy). For example, a related media data item may stay highlighted for the duration of relevancy.

At block 310, at any point during playback of the selected video subelement (or a pause state of the client video player), the user has the option to click on (or “drill down” to) any of the related media data items in the video programme. That is, the user may click on or otherwise access any related media data item regardless of its relevancy to the current video subelement or whether a displayed cue is associated with the related media data item (e.g., the related media data item is still highlighted), indicating that the related media data item is relevant to the video subelement. While a visual, aural, or other cue indicates to the user that a related media data item is relevant to the content being displayed by the selected video subelement for the duration of relevancy, the user is not restricted to only accessing the related media data item during the duration of relevancy.

If at block 310 the user does not access a related media data item, at block 311, the selected video subelement continues playback. Once the duration of relevancy of the related media data item triggered at block 309 has expired, the cue associated with the related media data item is no longer displayed or played by the client video player (e.g., the related media data item is no longer highlighted).

At block 312, at the end of playback of the video subelement, the client video player presents the user with a user interface in which the user can select the next sequential video element. However, the user retains the option to replay the previously viewed video subelement (e.g., the previous step), choose the next video subelement (e.g., the next step), select any video subelement (e.g., select any step available), select any related media data item (e.g., get further information), choose a different video programme or programme group all together (e.g., change the selected programme), or take another action. That is, the process may return to block 307 to receive a selection of content by the user.

If at block 310 the user accessed any of the related media data items while the selected video subelement was in playback mode, at block 315, the client video player pauses the selected video subelement to ensure that the user does not lose his or her position within the selected video subelement while the related media data item is displayed. Pausing the selected video subelement ensures that the user does not get a sense of losing track of the learning experience, especially when the related media data item relates to the content being presented by the video subelement.

If the user chooses to access a related media data item at block 310 or at block 313, at block 316, the server determines whether the related media data item is associated with a cost per click pricing scheme and logs the media file or files accessed, the user identifier, and other information. At block 317, the server downloads, streams, or otherwise transfers to the client video player the related media data item, plus any external URLs or other identifiers that are part of the related media data item. The client video player then displays, and may begin playback of, any related media data item. In some examples, the related media data item is presented atop the main video subelement to focus the attention of the user on the related media data item. In some examples, a graphical or other representation of the relationship between the video subelement and the related media data item being accessed remains displayed during presentation of the related media data item. Related media data is displayed to the user after s/he has chosen to access any of the related media data items in block 313 (i.e., the user has opted-in to the related media data).

If at block 318 the user accesses an external link while the related media data item is being presented, at block 319, a new browser window loads the external link. When triggering the external link, the client video player may send unique identifiers to the server or servers hosting the external media, such as for the purposes of establishing a commercial relationship between the client video player, the user, and the provider of the external media. Such relationships may identify the user as a potential customer of the provider of the external media, as linked from the client video player.

If at block 318 the user does not access an external link presented by the client video player, but instead chooses to close the related media data item, then at block 311, the client video player resumes playback of the video subelement that was active when the related media data item was accessed.

At any time during display of a video programme, at a block 314, the user may select to view a different video programme or group of video programmes. If at block 314 the user selects to view another video programme or group of video programmes, the process loops back to block 301 to process the user's selection. If at block 314 the user does not select to view another video programme or group of video programmes, the process loops back to block 307 to receive a selection of content by the user.

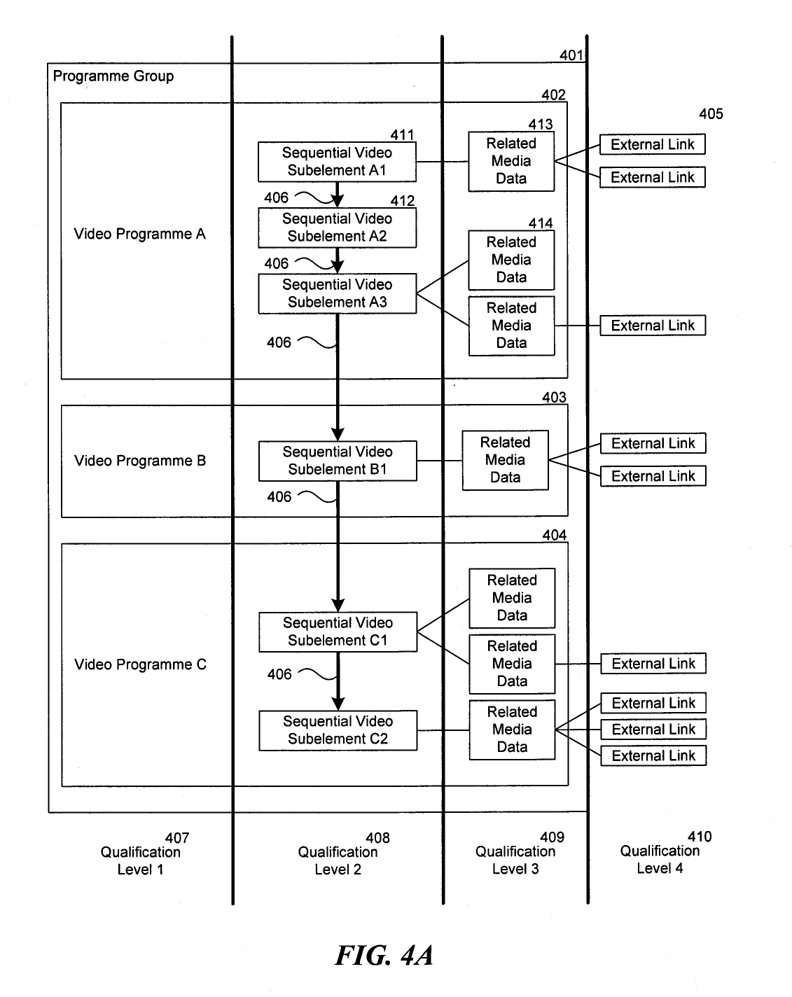

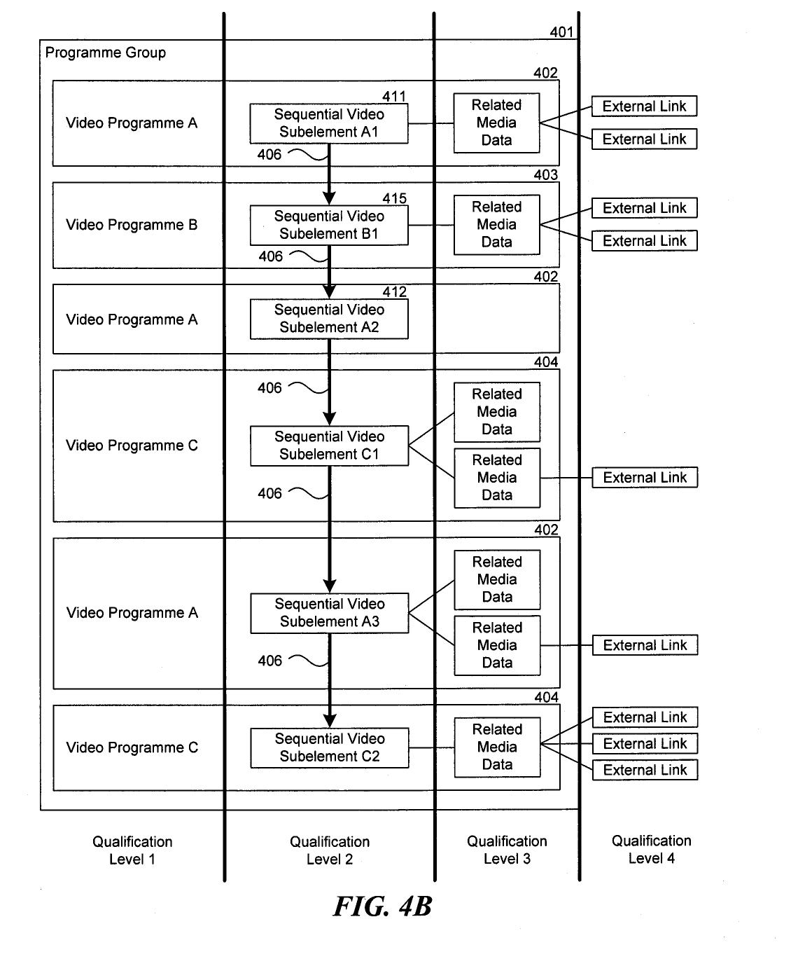

FIG. 4A illustrates the nested nature of elements that comprise a video programme group displayed in the client video player in at least one suitable system. The client video player displays a programme group 401 comprising three video programmes 402, 403, and 404. Each video programme comprises one or more sequential video subelements. For example, video programme A 402 has three sequential video subelements; video programme B 403 has one sequential video subelement; and video programme C 404 has two sequential video subelements. In some examples, sequential video elements are associated with related media data, although not every sequential video subelement need have related media data associated with it. For example, in some cases there may be one related media data item, in other cases there may be two or more, and in other cases there may be none. FIG. 4A depicts, for example, sequential video subelement A1 411 associated with one related media data item and sequential video subelement A2 412 associated with no related media data items. In addition some of the related media data items have external links 405, while others do not. FIG. 4A depicts, for example, related media data item 413 with two external links and related media data item 414 with no external links. As illustrated by FIG. 4A, not all sequential video subelements have the same structure.

FIG. 4A depicts video programmes 402, 403, and 404 ordered in a logical sequence. Video programme A 402 is presented first, followed by video programme B 403, followed by video programme C 404. In addition, the video subelements of each video programme are ordered in a logical sequence 406. For example, sequential video subelement A1 411 of video programme A 402 is presented before sequential video subelement A2 412 of video programme A 402, and so on. The user has the option of playing each video subelement sequentially, such as depicted by the path 406 in FIG. 4A, or in another order, allowing the user to select his/her path of learning.

From an educational, informational, and commercial point of view, the suitable systems presented in FIG. 4A contain up to four interest or qualification levels. A qualification level indicates the level of interest a user may have in the content presented by the client video player. The higher the qualification level (with qualification level one being the lowest level), the more interest the user has in the content and materials being presented. In qualification level 1 407, the user shows interest in the topics presented by the video programmes. As the user accesses video subelements in qualification level 2 408, it is inferred that the interest level of the user is higher than in qualification level 1 407. If the user chooses to access related media data items (which is optional, not mandatory, as described above) the user shows further interest in specific parts of the video subelements, demonstrating an even higher interest in qualification level 3 409. Furthermore, if the user chooses to access any of the available external links for the related media data items, whether for commercial purposes (e.g., “buy now”) or to acquire further information (e.g., “learn more”), at a qualification level 4 410 it is inferred that the user is very interested in taking further actions. In some examples of the system, these further actions include purchasing related products from third party partners. Alternatively or additionally, these further actions allow the user to access specific commercial or educational information on third party partners' products displayed on the partners' commercial or educational websites.

The suitable systems depicted in FIG. 4A can be illustrated by the following culinary learning example. The programme group 401 may be a meal comprising various video programmes 402, 403, and 404. For example, video programme A 402 may be an appetizer dish, video programme B 403 may be a main course dish, and video programme C 404 may be a dessert dish. The sequential video subelements, such as subelement A1 411 and A2 412, represent the steps to prepare each of the dishes. For example, the sequential video subelement A1 411 may be the preparation of ingredients for the appetizer dish, including chopping vegetables. The related media data 413 associated with subelement A1 411 may present information on what kinds of knives are best suited for the chopping vegetables and suggest a brand of knives to the user. An external link 405 associated with the related media data 413 may allow the user to purchase the brand of knives from a third party commercial partner, while another external link 405 may load the specifications and further information on the knives from the manufacturer's website. This example demonstrates that the higher the qualification level associated with the user's actions, the higher the value of the information and media is to the user, and the higher the value of the user is to the third party partners.

FIG. 4B illustrates elements that comprise a video programme group displayed in the client video player in at least one suitable system. FIG. 4B depicts a programme group 401 that comprises three video programmes 402, 403, and 404. However, unlike a sequence 406 of video subelements that follows the sequence of video programmes, such as that depicted in FIG. 4A, the sequence of video subelements in FIG. 4B is dictated by other sequential logic (e.g., time scheduling). FIG. 4B depicts the presentation of video subelement A1 411, which is part of video programme A 402, followed by video subelement B1 415, which is part of the video programme B 403, followed by video subelement A2 412 which is part of the video programme A 402, and so forth. That is, the sequence of video subelements in a video programme group may follow an order that differs from the sequence of the video programmes.

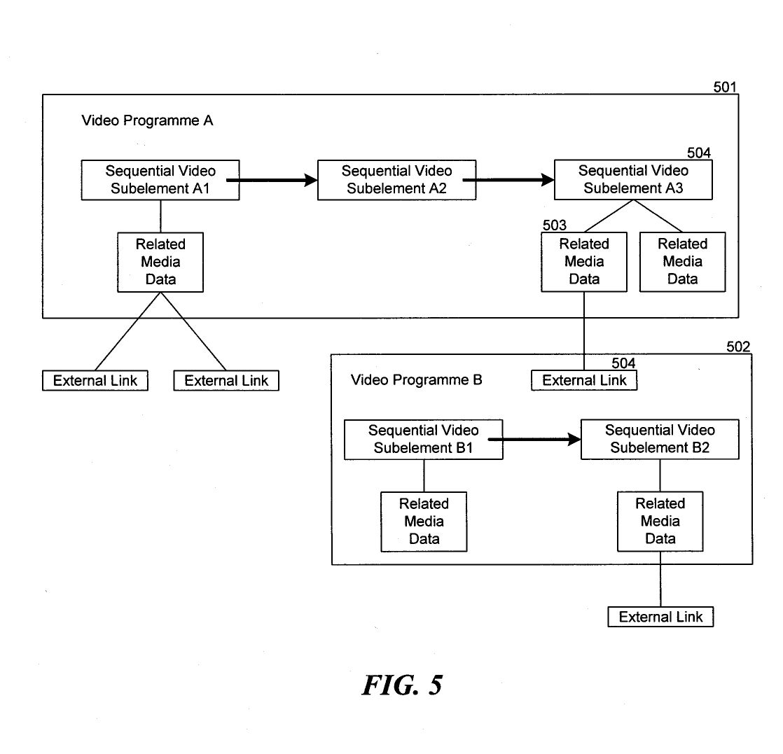

FIG. 5 illustrates a link between video programmes in at least one suitable system. FIG. 5 depicts video programme A 501 that links to a video programme B 502 by an external link 504 associated with a related media data item 503 of a video subelement A3 504. As a culinary example, the video subelement A3 504 may be the plating of a recipe video programme 501, the related media data item 503 may provide information on garnishment, which in turn may include a link 504 to a full video programme recipe 502. As indicated by FIG. 5, external links may comprise other video programmes that are related to the original video subelement or video programme.

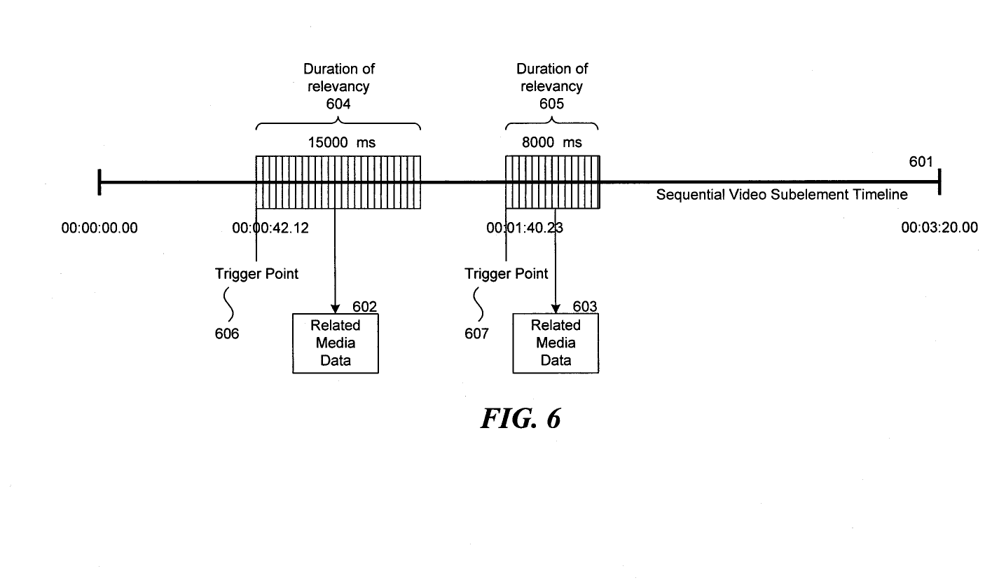

FIG. 6 illustrates how and when the system indicates to the user that related media data is relevant to the content presented in a sequential video subelement. FIG. 6 depicts a timeline 601 of a sequential video subelement that has a duration of 3 minutes and 20 seconds. The sequential video subelement depicted in FIG. 6 includes related media data items 602 and 603. During playback of the video subelement, the client video player will present links to each of the related media data items 602 and 603. In some examples, a visual, audio, or other cue will be displayed for each of the related media data items (e.g., the related media data items will be highlighted) during a duration of relevancy, or a period of time in which the related media data item is relevant to the content presented by the sequential video subelement. FIG. 6 depicts duration of relevancy 604 for media data item 602 and duration of relevancy 605 for media data item 603. As the video subelement plays, when the client video player reaches 42 seconds and 12 frames, the trigger point 606 for the first related media data item 602 is reached. The duration of relevancy 604 indicates that for the 15,000 milliseconds following the trigger point 606, the related media data item 602 is relevant to the content presented by the sequential video subelement. In some examples, during this duration of relevancy 604, a visual, audio, or other cue is displayed associated with the related media data item 602 (e.g., the related media data item is highlighted). In addition, FIG. 6 depicts a second related media data item 603 with a trigger point 607 at 1 minute, 40 seconds and 23 frames and a duration of relevancy of 8000 milliseconds.

As a culinary example, the video subelement 601 may relate to the step of cooking pasta in a recipe for a pasta dish, and the first related media data item 602 may be an explanation of how to determine if the pasta is cooked “al dente.” In this example, beginning at second 42 and 12 frames and lasting for a duration of 15000 milliseconds, the pasta cooking video subelement would mention, without offering a detailed explanation, that the pasta needs to be cooked “al dente”. Before and after this time period, the video subelement may explain other concepts related to the process of cooking the pasta. For example, trigger point 607 may be for related a media data item that offers information about how to trim fresh herbs. The trigger point 607 may be initiated and the duration of relevancy 605 may continue while the pasta cooking video subelement instructs the user to chop fresh herbs. As described above, while the duration of relevancy 604 or 605 may indicate a time period for which the related media data is relevant to the content displayed in the video subelement, the user can access the related media data before, during, or after playback of the video subelement with which it is associated. In some examples, the trigger points 606 and 607, the durations of relevancy 604 and 605, and the related media data 602 and 603 are embedded in the media file for the video subelement. In other examples, these elements are not embedded in the media file for the video subelement; rather, these elements are managed by the server, which may change, add to, or remove any of these elements, such as via a backend management system. In such examples, it is not necessary for these elements to be defined when the video is encoded; instead, the elements may be subsequently defined.

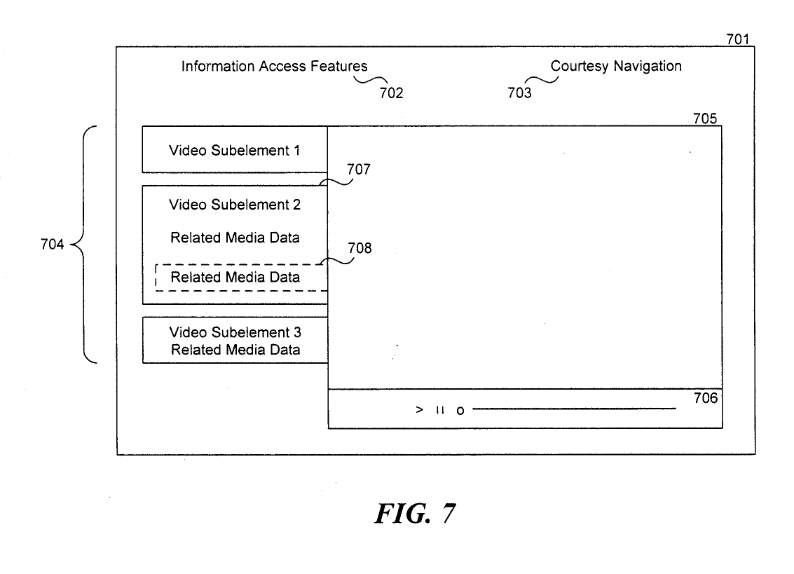

FIG. 7 depicts a user interface 701 for a video programme presented by the client video player in at least one suitable system. The user interface 701 comprises information access features 702, which provide access to textual and other data that relates to a video programme or programme group. As a culinary example, a video programme may be a recipe, and the information access features 702 may comprise features such as access to chef notes, recipe summary information, full recipe text, and other features. In addition, the user interface 701 comprises courtesy navigation 703, which allows the user to access enhancement features that are not necessarily related to the content of the video programme. As a culinary example, the courtesy navigation 703 may comprise features to bookmark the recipe video programme, send an email to a friend informing him/her of the selected video programme, rating features by which the user may provide a comparative rating of the selected video programme, and other features. In addition, the video programme depicted in FIG. 7 comprises three sequential video subelements 704, a video subelement display area 705, where a selected video subelement plays, and transport controls 706 for the selected video subelement, which may be used by the user to control playback of the selected video subelement. In addition, video subelement 2 707 contains two related media data items. The second related media data item is highlighted 708, such as during its duration of relevancy within the video subelement 2 707.

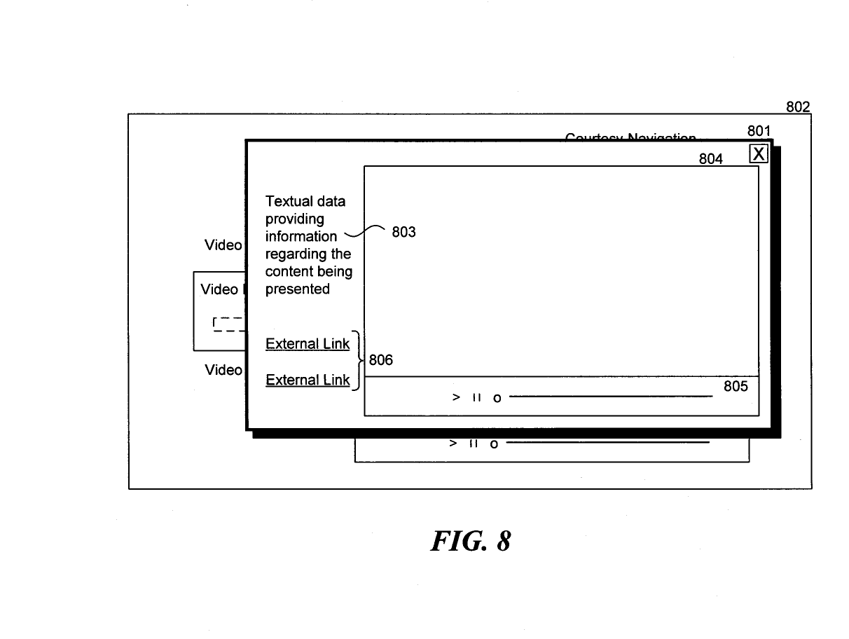

FIG. 8 illustrates a user interface 801 in which related media data is presented by the client video player in at least one suitable system. As depicted by FIG. 8, the user interface 801 for the related media data may be displayed atop the user interface 802 for the video programme, for reasons that include graphically indicating the dependency relationship between the related media data and the video subelement and/or video programme. The user interface 801 comprises textual information 803 that is associated with the related media data content displayed in the display area 804. For example, a video may be presented in the display area 804, and text describing the video presentation 803 may be displayed. In addition, the user interface 801 comprises transport controls 805, which may be located, for example, beneath the display area 804. The user interface 801 may also comprise one or more external links 806 that are associated with the related media data. By selecting one of these links, the user may take further action regarding the related media data, as described above.

Systems and modules described herein may comprise software, firmware, hardware, or any combination(s) of software, firmware, or hardware suitable for the purposes described herein. Software and other modules may reside on servers, workstations, personal computers, computerized tablets, personal digital assistants (PDAs), and other devices suitable for the purposes described herein. In other words, the software and other modules described herein may be executed by a general-purpose computer, e.g., a server computer, wireless device or personal computer. Those skilled in the relevant art will appreciate that aspects of the invention can be practiced with other communications, data processing, or computer system configurations, including: Internet appliances, hand-held devices (including PDAs), wearable computers, all manner of cellular or mobile phones, multi-processor systems, microprocessor-based or programmable consumer electronics, set-top boxes, network PCs, mini-computers, mainframe computers, and the like. Indeed, the terms “computer,” “server,” “host,” “host system,” and the like are generally used interchangeably, and refer to any of the above devices and systems, as well as any data processor. Furthermore, aspects of the invention can be embodied in a special purpose computer or data processor that is specifically programmed, configured, or constructed to perform one or more of the computer-executable instructions explained in detail herein.

Software and other modules may be accessible via local memory, via a network, via a browser or other application in an ASP context, or via other means suitable for the purposes described herein. Aspects of the invention can also be practiced in distributed computing environments where tasks or modules are performed by remote processing devices, which are linked through a communications network, such as a Local Area Network (LAN), Wide Area Network (WAN), or the Internet. In a distributed computing environment, program modules may be located in both local and remote memory storage devices. Data structures described herein may comprise computer files, variables, programming arrays, programming structures, or any electronic information storage schemes or methods, or any combinations thereof, suitable for the purposes described herein. User interface elements described herein may comprise elements from graphical user interfaces, command line interfaces, and other interfaces suitable for the purposes described herein. Screenshots or user interfaces presented and described herein can be displayed differently as known in the art to input, access, change, manipulate, modify, alter, and work with information.

Aspects of the invention may be stored or distributed on computer-readable media, including magnetically or optically readable computer discs, hard-wired or preprogrammed chips (e.g., EEPROM semiconductor chips), nanotechnology memory, biological memory, or other data storage media. Indeed, computer implemented instructions, data structures, screen displays, and other data under aspects of the invention may be distributed over the Internet or over other networks (including wireless networks), on a propagated signal on a propagation medium (e.g., an electromagnetic wave(s), a sound wave, etc.) over a period of time, or they may be provided on any analog or digital network (packet switched, circuit switched, or other scheme).

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof, means any connection or coupling, either direct or indirect, between two or more elements; the coupling of connection between the elements can be physical, logical, or a combination thereof. Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number respectively. The word “or,” in reference to a list of two or more items, covers all of the following interpretations of the word: any of the items in the list, all of the items in the list, and any combination of the items in the list.

The above detailed description of embodiments of the invention is not intended to be exhaustive or to limit the invention to the precise form disclosed above. While specific embodiments of, and examples for, the invention are described above for illustrative purposes, various equivalent modifications are possible within the scope of the invention, as those skilled in the relevant art will recognize. For example, while processes or blocks are presented in a given order, alternative embodiments may perform routines having steps, or employ systems having blocks, in a different order, and some processes or blocks may be deleted, moved, added, subdivided, combined, and/or modified to provide alternative or subcombinations. Each of these processes or blocks may be implemented in a variety of different ways. Also, while processes or blocks are at times shown as being performed in series, these processes or blocks may instead be performed in parallel, or may be performed at different times.

The teachings of the invention provided herein can be applied to other systems, not necessarily the system described above. The elements and acts of the various embodiments described above can be combined to provide further embodiments. Any patents and applications and other references noted above, including any that may be listed in accompanying filing papers, are incorporated herein by reference. Aspects of the invention can be modified, if necessary, to employ the systems, functions, and concepts of the various references described above to provide yet further embodiments of the invention.

These and other changes can be made to the invention in light of the above Detailed Description. While the above description describes certain embodiments of the invention, and describes the best mode contemplated, no matter how detailed the above appears in text, the invention can be practiced in many ways. Details of the system and method for classifying and transferring information may vary considerably in its implementation details, while still being encompassed by the invention disclosed herein. As noted above, particular terminology used when describing certain features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific embodiments disclosed in the specification, unless the above Detailed Description section explicitly defines such terms. Accordingly, the actual scope of the invention encompasses not only the disclosed embodiments, but also all equivalent ways of practicing or implementing the invention under the claims.

While certain aspects of the invention are presented below in certain claim forms, the inventors contemplate the various aspects of the invention in any number of claim forms. For example, while only one aspect of the invention is recited as a means-plus-function claim under 35 U.S.C. §112, sixth paragraph, other aspects may likewise be embodied as a means-plus-function claim, or in other forms, such as being embodied in a computer-readable medium. (Any claims intended to be treated under 35 U.S.C. §112, sixth paragraph will begin with the words “means for.”) Accordingly, the inventors reserve the right to add additional claims after filing the application to pursue such additional claim forms for other aspects of the invention.

I/We claim:

1. A computer-implemented method of providing to a client computer system a digital video programme and digital media content related to the digital video programme to be displayed to a user via a client video player, the method comprising:
identifying subelements of the digital video programme to which the related digital media content is relevant, wherein the digital video programme is a step by step instructional narrative, wherein each step of the digital video programme may include a subelement, and wherein the related digital media content comprises drill down information and/or advertisements directly related to the subelement;
identifying, for at least one identified subelement, a logical relationship between the digital video programme and the related digital media content;
receiving a request from the client computer system to access the digital video programme;
providing to the client computer system displayable identifiers associated with the digital video programme and the related digital media content, the identifiers for display to a user via the client video player;
receiving from the client computer system a selection of one of the provided identifiers, the selected identifier having been chosen by the user before, during, or after display of the digital video programme via the client video player;
when the selected identifier is associated with the digital video programme, providing the associated digital video programme or a link to the associated digital video programme to the client computer system for display to the user via the client video player; and
when the selected identifier is associated with related digital media content, providing the associated related digital media content or a link to the associated related digital media content to the client computer system for display to the user via the client video player.

2. The method of claim 1, further comprising:
for each identified relationship, identifying a duration of relevancy, wherein the duration of relevancy is a time period during the display of the digital video programme in which the related digital media content is directly relevant to the digital video programme; and
providing to the client computer system information about the identified relationships, the information for communication to the user via the client video player during the identified durations of relevancy.

3. The method of claim 1 wherein the related digital media content includes at least one of educational, informational, or commercial content.

4. The method of claim 1, further comprising recording user interactions with the client video player and creating unique user profiles based on the recorded user interactions.

5. The method of claim 1 wherein the related digital media content is managed by a server, and wherein the related digital media content is modifiable by the server after the digital video programme is encoded.

6. A system for providing to a client computer system a digital video programme and digital media data related to the digital video programme, the digital video programme and related digital media data for display to a user, the system comprising:
means for storing relationships between the digital video programme and the related digital media data, wherein the related digital media data comprises drill down information directly related to the digital video programme;
means for receiving a request from a client computer system for access to the digital video programme;
means for providing to the client computer system identifiers associated with the digital video programme and the related digital media data, the identifiers for display to a user by the client computer system;
means for communicating to the client computer system the relationships between the digital video programme and the related digital media data, the relationships for communication to the user;
means for receiving from the client computer system a selection of one of the provided identifiers, the selected identifier having been chosen by the user at any time;
means for, when the selected identifier is associated with the digital video programme, providing the associated digital video programme or a link to the associated digital video programme to the client computer system for display to the user; and
means for, when the selected identifier is associated with the related media data, providing the associated related digital media data or a link to the associated related digital media data to the client computer system for display to the user.

7. The system of claim 6, further comprising means for recording user interactions with the client video player and means for creating unique user profiles based on the recorded user interactions.

8. The system of claim 6, further comprising:
means for identifying a duration of relevancy for each stored relationship, wherein the duration of relevancy is a time period during the display of the digital video programme in which the related digital media data is directly relevant to the digital video programme,
wherein the relationships are for communication to the user via the client video player during the identified durations of relevancy.

9. The system of claim 6, further comprising voiceover data associated with the digital video programme or the related digital media data.

10. The system of claim 6 wherein the related digital media data comprises advertisements.

11. The system of claim 6 wherein the identifiers are for display to the user by the client computer system as a sequence of digital video programme subelements.

12. The system of claim 6 wherein the related media data comprises at least one link to a video programme.

13. A computer-readable medium encoded with processing instructions for implementing a method, performed by a computer, for providing to a user via a client video player a digital video programme and digital media content related to the digital video programme, the method comprising:
receiving a request from the user to access the digital video programme;
requesting access to the digital video programme from a server;
receiving from the server identifiers associated with the digital video programme and the related digital media content;
receiving from the server information about relationships between the digital video programme and the related digital media content;
displaying the received identifiers to the user via the client video player and communicating to the user the received information about the relationships between the digital video programme and the related digital media content;
allowing the user to select the displayed identifiers before, during, or after display of the digital video programme;
receiving a selection by the user of one of the displayed identifiers;
when the selected identifier is associated with the digital video programme, retrieving from the server the associated digital video programme or a link to the associated digital video programme, and displaying to the user via the client video player the associated digital video programme or the link to the associated digital video programme; and
when the selected identifier is associated with related digital media content, retrieving from the server the associated related digital media content or a link to the associated related digital media content, and displaying to the user via the client video player the associated related digital media content or the link to the associated related digital media content.

14. The computer-readable medium of claim 13 wherein the method further comprises recording a user interaction with the client video player and creating a unique user profile based on the recorded user interaction.

15. The computer-readable medium of claim 13 wherein the method further comprises:
receiving from the server, for each of the relationships for which information is received, an indication of a duration of relevancy, wherein the duration of relevancy is a time period during the display of the digital video programme in which the related digital media content is relevant to the digital video programme; and
wherein the communicating to the user the received information about the relationships comprises communicating the received information during the indicated durations of relevancy.

16. The computer-readable medium of claim 13 wherein the method further comprises presenting a group of video programmes, wherein the group of video programmes comprises multiple video programmes that have an educational, informational, or commercial relationship with one another.

17. The computer-readable medium of claim 13 wherein the communicating to the user the received information about the relationships comprises displaying a visual, aural, or other indicator.

18. The computer-readable medium of claim 15 wherein the communicating to the user the received information about the relationships comprises displaying a visual, aural, or other indicator during the indicated durations of relevancy.

19. The computer-readable medium of claim 18 wherein the method further comprises allowing the user to select an identifier associated with the related digital media data regardless of whether the selection is made during the duration of relevancy associated with the related digital media data.

20. The computer-readable medium of claim 13 wherein the method further comprises, when the digital video programme is being displayed via the client video player when the selected identifier is received and the selected identifier is associated with the related digital media content, the method further comprises:
pausing the display of the digital video programme;
displaying the related digital media content to the user via the client video player; and
when the display of the related media content has ended, resuming the display of the digital video programme.
